(19) United States
(12) Patent Application Publication
(10) Pub. No.: US 2003/0218535 A1
(43) Pub. Date: Nov. 27, 2003

(54) Method and apparatus for displaying advertising indicia on a wireless device

(76) Inventor: Housh Khoshbin, Hawthorn Woods, IL (US)

Correspondence Address: Wallenstein & Wagner, Ltd., 53rd Floor, 311 S. Wacker Drive, Chicago, IL, 60606-6630, US

(21) Appl. No.: 10/359,009

(22) Filed: Feb. 5, 2003

Related U.S. Application Data
(63) Continuation-in-part of application No. 09/638,825, filed on Aug. 14, 2000.

(51) Int. Cl. H04Q 7/00

(52) U.S. Cl. 340/7.53; 340/7.48; 340/5.41; 705/18; 705/44

(57) ABSTRACT

The present invention is a wireless device, such as a pager, that has an identity, such as a frequency and a capcode. The wireless device is provided for notifying a user of a message, such as a telephone number, directed specifically to the identity of the wireless device. The wireless device includes a housing, a display attached to the housing, a driver connected to the display for causing indicia to appear on the display, a controller, such as a microprocessor, connected to the driver for sending to the display a signal comprising indicia to appear on the display, a memory, and a receiver connected to the controller for receiving a page signal directed specifically to the identity of the wireless device and for communicating the page signal to the controller. When the controller receives the page signal received by the receiver, the controller sends to the driver a signal comprising the advertising indicia for causing the display to display the advertising indicia. The controller will then send to the driver a signal comprising message for display on the display. The wireless device further includes a dynamic infrared transfer system for transmitting information, such as financial information. A method is also provided in relation to the use of the wireless device.

### RELATED APPLICATION

This application is a Continuation-in-Part of U.S. Utility patent application Ser. No. 09/638,825, entitled “Method and Apparatus for Displaying Advertising Indicia on a Wireless Device,” filed Aug. 14, 2000. This application is incorporated herein by reference.

### TECHNICAL FIELD

The present invention generally relates to wireless devices for paging their users. More specifically, the present invention relates to a method and apparatus for displaying advertisements on a wireless device, such as a pager.

### BACKGROUND

Wireless devices, such as pagers, have become common. These wireless devices have allowed individuals to communicate more efficiently in business and personal settings. Typical pagers include a display for displaying a message, such as a phone number to return a call. Typical pagers also include a receiver which “listens” for its particular signal to be broadcast from a base station. Once the pager's individual signal is broadcast, the receiver in the pager will recognize the signal has been sent and will indicate an alarm to the user of the pager. The pager will then display the message on the display.

One particular type of pager is disclosed in U.S. Pat. No. 5,999,088 issued to Sibbitt, entitled “Information Display Pager.” The Sibbitt pager provides a method and apparatus of providing active entertainment for persons waiting for service. Such persons are provided with an electronic pager assembly for notifying when service is available. The pager includes an electronically controllable pager assembly having a controllable screen display which is programmed with information likely to be desirable to a person holding the pager. A set of instructions enabling a person to access the information programmed in the pager assembly is printed on the assembly. The pager notification capability functions regardless of whether the information display is or is not active. The information is not automatically placed on the screen. Moreover, the user can choose to completely ignore the information within the pager and to wait until the pager “vibrates” as the notification that the user is ready to be seated in the restaurant.

Another particular type of pager is disclosed in U.S. Pat. No. 6,008,739, issued to Hymel, entitled “Increasing The Size Of Memory Available For Storing Messages In Response To The User Reading Advertisements In A Selective Call Receiver.” The Hymel patent is directed to a method of encouraging a user of an SCR (Selective Call Receiver) to read advertisements stored in the SCR. The user is provided with an initial level of access to a feature of the SCR that enhances the SCR's usefulness. When the user reads an advertisement, additional access to that feature is provided for a predetermined time period. Preferably, the feature is memory space, and each time the user reads an advertisement, the memory space available for storing messages is temporarily increased.

Another further particular type of pager is disclosed in U.S. Pat. No. 6,031,467, issued to Hymel et al., entitled “Method In a Selective Call Radio For Ensuring Reception Of Advertisement Messages.” The Hymel et al. patent discloses an SCR that receives personal messages and corresponding advertisement messages, and includes a receiver, memory, presentation circuit and processor. The processor is adapted to cause the receiver to receive a personal message, to determine whether a corresponding advertisement message has been previously stored in the memory, and in the event the corresponding advertisement message is not found, cause the presentation circuit to present the personal message to a user of the SCR. Additionally, the processor causes the presentation circuit to present a warning to the user that the SCR must receive the corresponding advertisement message within a predetermined time. If the corresponding advertisement message is not received within the predetermined time, the processor immediately disables the SCR. Thus, the advertisement messages can be lost when the pager is not on. In addition, a complicated structure is needed to ensure and encourage viewing of advertisement messages.

The present invention is provided to solve these and other problems.

### SUMMARY

The present invention is a wireless device, such as a pager, that has an identity, such as a frequency and capcode. The wireless device is provided for notifying a user of a page, such as a telephone number, directed specifically to the identity of the wireless device. The wireless device includes a housing and a display attached to the housing. The wireless device further includes a driver connected to the display for causing indicia to appear on the display. The wireless device further includes a controller, such as a microprocessor connected to the driver for sending to the display a signal comprising indicia to appear on the display. The wireless device also has a memory preprogrammed with advertising indicia and a receiver connected to the controller for receiving a page signal directed specifically at the identity of the wireless device and for communicating the page signal to the controller. When the controller receives the page signal received by the receiver, the controller will then send to the driver a signal comprising the advertising indicia preprogrammed in the memory for causing the display to display the advertising indicia. The controller will then send to the driver a signal comprising an identification of the message for display on the display.

The display can be a liquid crystal display (LCD) and the memory can be an electrically eraseable programmable read only memory (EEPROM). The advertising indicia can be a logo of a company, a company name, or other advertising indicia.

When the controller receives the page signal received by the receiver, the controller can then immediately send to the LCD driver a signal comprising the advertising indicia in the memory for causing the LCD to display the advertising indicia. The controller can then send to the LCD driver, within five seconds or less from the sending of the signal comprising the advertising indicia, a signal comprising the message.

In an additional embodiment of the present invention, the present invention is a memory device for a wireless device with its structure and functions generally as described. The memory device has a storage location preprogrammed with advertising indicia. When the controller receives the page signal received by the receiver, the controller will then send to the driver a signal comprising the advertising indicia preprogrammed in the memory for causing the display to display the advertising indicia, and the controller will then send to the driver a signal comprising an identification of the message for display on the display.

In a further embodiment of the present invention, the present invention is a method of providing advertising indicia to a user of a wireless device on the display of the wireless device. The wireless device notifies the user of a page directed specifically to an identity of the wireless device. The method comprises the steps of receiving an advertising request for placement of advertising indicia within the wireless device; storing in a memory located within the wireless device the advertising indicia, before the user obtains permanent possession of the wireless device; providing permanent possession of the wireless device to the user; and, providing paging service to the user. The user receives the page signal. The advertising indicia stored in the memory of the wireless device then appears on the display of the wireless device. The message then appears on the display of the wireless device.

In an additional embodiment of the present invention, the present invention is a method for providing advertising indicia to a plurality of users of wireless devices on a display of the wireless device. The wireless device notifies a user of a page directed specifically to an identity of the wireless device. The method comprises the steps of providing a plurality of wireless devices to an advertiser that may want to advertise to the users of the wireless devices, wherein each wireless device has an identity; receiving a request from the advertiser for placement of advertising indicia on a sub-set of the plurality of users of wireless devices wherein the request for placement of advertising indicia comprises a demographic criteria for selecting the sub-set; determining the identities of the sub-set for placement of the advertising indicia wherein the identities of the sub-set have user demographic information corresponding to the demographic criteria received from the advertiser; and, providing paging service to the plurality of users, wherein the wireless devices of the sub-set receive the advertising indicia and the advertising indicia appears on the display of the wireless devices of the sub-set.

In a further embodiment of the present invention, the present invention is a system and method for providing a financial transaction to a user of a pager. The system includes an interactive point of sale terminal connected to an ATM network. The point of sale terminal comprises an input device for entering a personal identification number (PIN), an infrared receiver for receiving an infrared signal and an infrared transmitter for transmitting an infrared signal. The system further includes a wireless device for transmitting an infrared signal to the interactive point of sale terminal. The wireless device comprises an identification corresponding to a personal identification number, a memory comprising financial information, a processor connected to the memory for processing the financial information and wireless device identification to form an infrared transaction signal, and a transmitter connected to the processor for transmitting the infrared transaction signal to the interactive point of sale terminal.

In an additional embodiment of the present invention, the present invention is a system for permitting access to a device having controller access. The system comprises an access control system connected to a device requiring controlled access. The access control system has an infrared receiver for receiving an infrared signal. The system further includes a wireless device for transmitting an infrared signal to the access control system. The wireless device comprises an identification, a memory comprising identification information, a processor connected to the memory for processing the identification information to form an infrared signal, and a transmitter connected to the processor for transmitting the infrared signal to the access control system.

In an additional embodiment of the present invention, the present invention is a method for providing advertising indicia to a sender of a page to a user of a wireless device. The wireless device notifies the user of a page directed specifically to an identity of the wireless device. The method comprises the steps of providing a plurality of wireless devices to an advertiser that may want to advertise to a sender of a page to one of a plurality of users of the wireless devices wherein each wireless device has an identity; receiving a request from the advertiser for placement of an audible advertising message on a voice mail system; and, providing the audible advertising message to the sender of the page in response to the sender of the page requesting to leave a voice mail message directed specifically to the identity of the wireless device of the user.

In an additional embodiment of the present invention, the present invention is a method for providing advertising to a sender of a page to a user of a wireless device. The wireless device notifies the user of a message directed specifically to an identity of a wireless device. The method comprises the steps of providing a website to the sender for sending the page to the user of the wireless device, the website having a field for identifying the identity of the wireless and a field for identifying the message; receiving a request from the advertiser for placement of advertising indicia through the website; and, displaying the advertising indicia in response to the sender transmitting a page to a specific identity of the wireless device.

Other features and advantages of the present invention will be apparent from the Figures, Detailed Description, and claims below. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is one embodiment of a wireless device of the present invention.

FIG. 2 is a block diagram of one embodiment of the process of implementing advertising indicia into the wireless device of the present invention.

FIG. 3A is an illustration of the main menu presenting the personal messages folder of the present invention.

FIG. 3B is an illustration of the individual messages stored in the personal messages folder of the present invention.

FIG. 3C is an illustration of the selected message stored in the personal messages folder of the present invention.

FIG. 4 is a memory allocation of one embodiment of the wireless device of the present invention.

FIG. 5 is a flow diagram of one embodiment of what appears on the display of the wireless device of the present invention.

FIG. 6A is an illustration of the main menu presenting the Maildrop messages folder of the present invention.

FIG. 6B is an illustration of the channel selection screen highlighting the Sports Channel stored in the Maildrop messages folder of the present invention.

FIG. 6C is an illustration of the channel selection screen highlighting the News Channel stored in the Maildrop messages folder of the present invention.

FIG. 6D is an illustration of the channel selection screen highlighting the Stocks Channel stored in the Maildrop messages folder of the present invention.

FIG. 6E is an illustration of the channel selection screen highlighting the Custom Channel stored in the Maildrop messages folder of the present invention.

FIG. 7A is an illustration of the individual Maildrop messages stored in the Maildrop messages folder of the present invention.

FIG. 7B is an illustration of the selected Maildrop message stored in the Maildrop messages folder of the present invention.

FIG. 8A is a block diagram of the transmitter module of the dynamic infrared transfer system of the present invention.

FIG. 8B is a block diagram of the receiver module of the dynamic infrared transfer system of the present invention.

FIG. 9A is an illustration of the main menu presenting the Coupon Channel of the present invention.

FIG. 9B is an illustration of the individual Coupons stored in the coupon memory of the present invention.

FIG. 9C is an illustration of the selected coupon stored in the coupon memory of the present invention.

FIG. 9D is a block diagram of the point of sale system of the present invention.

FIG. 9E is a block diagram of the point of sale terminal of the point of sale system of the present invention.

FIG. 10A is an illustration of the main menu presenting the Payment Channel of the present invention.

FIG. 10B is an illustration of a merchant payment option of the present invention.

FIG. 10C is an illustration of a VISA credit card payment option of the present invention.

FIG. 10D is an illustration of a MasterCard credit card payment option of the present invention.

FIG. 10E is an illustration of a Discover credit card payment option of the present invention.

FIG. 11A is a block diagram of the financial point of sale system of the present invention.

FIG. 11B is a block diagram of the financial point of sale terminal of the financial point of sale system of the present invention.

FIG. 11C is a block diagram of the multiple payment system of the present invention.

FIG. 11D is a block diagram of the financial point of sale terminal of the multiple payment system of the present invention.

FIG. 12 is a block diagram of the access control system of the present invention.

FIG. 13 is a block diagram of one embodiment of the process of providing advertising indicia to a sender of a page.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

### Hardware

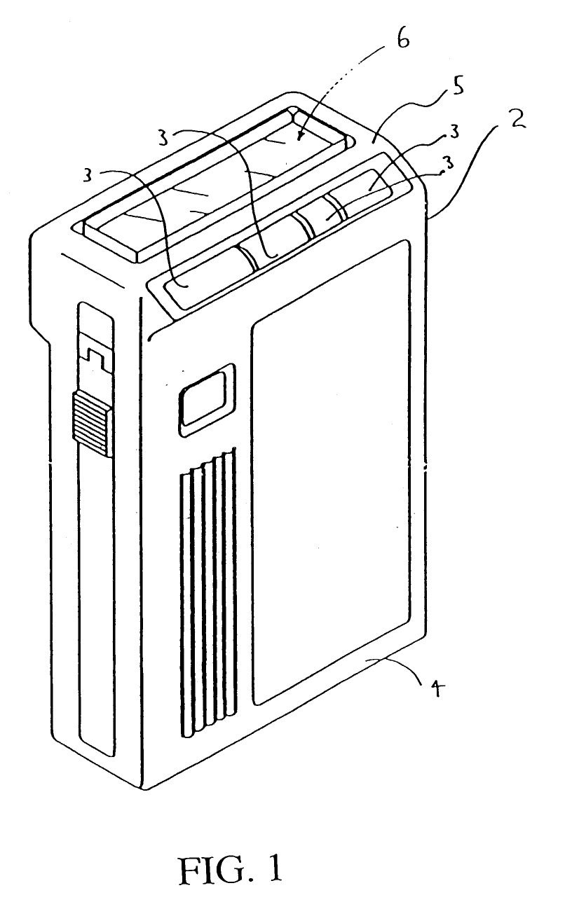

With reference to FIG. 1, one form of a wireless device, a pager 2, is shown. The pager 2 has an identity in the form of a frequency or small frequency range with which signals are sent to the pager 2, and which the pager 2 will recognize and respond to. The pager 2 is used for notifying a user of a page directed specifically to the pager 2. The page can be a person or a number to reach the person sending the page. The pager 2 has a housing 4 and a display 6 attached to the housing 4. The display 6 may be a liquid crystal display (LCD). The pager 2 includes a plurality of buttons 3 for allowing the user to control operation of the pager 2, such as selecting a message to read or a folder to open. The buttons 3 may be soft buttons thereby allowing their functions can be changed or modified allowing different screens to utilize different functions for the same buttons. The display 6 and the plurality of buttons 3 create an interface 5 by which the user operates the pager 2.

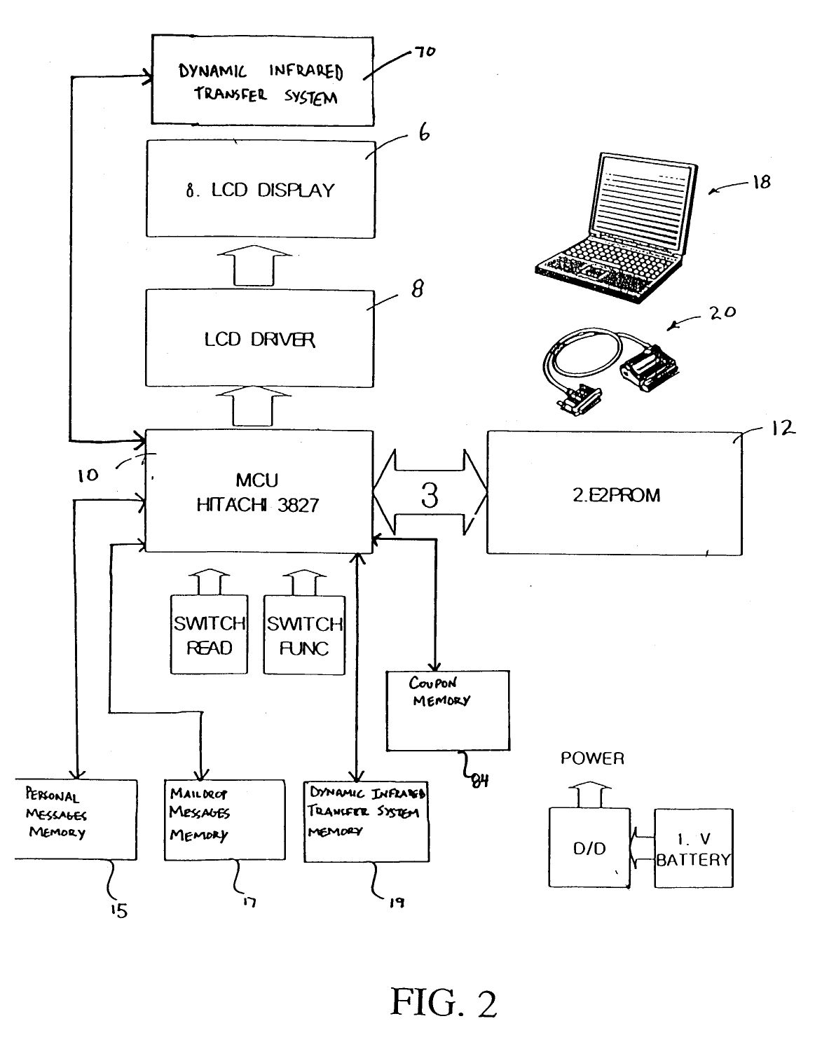

With further reference to FIG. 2, a display driver 8 is electrically connected to the display 6 for causing indicia to appear on the display 6. The display driver 8 may be a liquid crystal display driver. A controller or microprocessor 10 is connected to the display driver 8 for sending to the display 6 a signal that has indicia therein. In one form of the present invention, the controller 10 is an MCU Hitachi 3827 microprocessor. The controller 10 and the display driver 8 work together, as one of ordinary skill in the art would understand, to cause the indicia to appear on the display 6. The pager 2 also has an electrically erasable programmable read only memory (EEPROM) 12. The EEPROM 12 is preprogrammed with advertising indicia, as will be further described below. The preprogrammed advertising indicia therein can be changed, when the EEPROM 12 or other such changeable memory is used. The pager 2 further includes a personal messages memory 15 for storing messages received by the pager 2. The pager 2 has an audible and/or vibrating alarm for notifying the user when a page is taking place or has taken place. The pager 2 further comprises a power source for powering the controller 10, the display 6, and other components needing a power source. A receiver is electrically connected to the controller, as one of ordinary skill in the art would understand, for receiving a page signal directed specifically at the identity of the pager 2. The receiver will communicate the page signal to the controller 10 and the alarm for notifying the user of the page.

### Receiving a Page

In one form of the present invention, when the controller 10 receives the page signal sent to the controller 10 by the receiver, after the receiver receives the signal, the controller 10 immediately sends to the display driver 8 a signal comprising the advertising indicia in the EEPROM 12 for causing the display 6 to display the advertising indicia. The advertising indicia can be the name of a company, a logo, or some other form of advertising indicia. Further, the advertising indicia may be a full motion graphic, such as a FLASH graphic. The controller 10 will then send to the display driver a signal comprising a message, such as a number or person's name, or both. Preferably, the signal comprising the message it sent to the display driver 8 within five seconds or less from the sending of the signal comprising the advertising indicia. In this way the user of the pager 2 does not have to wait an unnecessary amount of time, with the understanding that the user knows it has received the pager and the paging service for little or no charge.

In an even further embodiment of the present invention, the controller 10 can be programmed such that the advertising indicia 16 will appear on the display 6 for a selected length of time before the message is displayed on the display 6. As described above, the pager 2 has an audible and/or vibrating alarm for notifying a user when a page is taking place, or has taken place. The programmable time for the advertising indicia to be displayed in the display 6 can begin after the audible alarm is complete. Alternatively, the time that the advertising indicia is displayed on the display can begin about the same time as an alarm begins. These programmable features allow for flexibility in meeting the requests and demands of companies and individuals wishing to place advertising within a wireless device.

In another form of the invention, when the controller 10 receives the page signal received by the receiver, the pager 2 enters a NEW MESSAGE RECEIVED mode. In the case of the NEW MESSAGE RECEIVED mode, the user can wait to view the message until a later time after the alarm indicates the page has been received. The user can then press one of the buttons 3 to select to view the message. When the user selects to do this, the advertising indicia will be displayed on the display 6 in the manner described above.

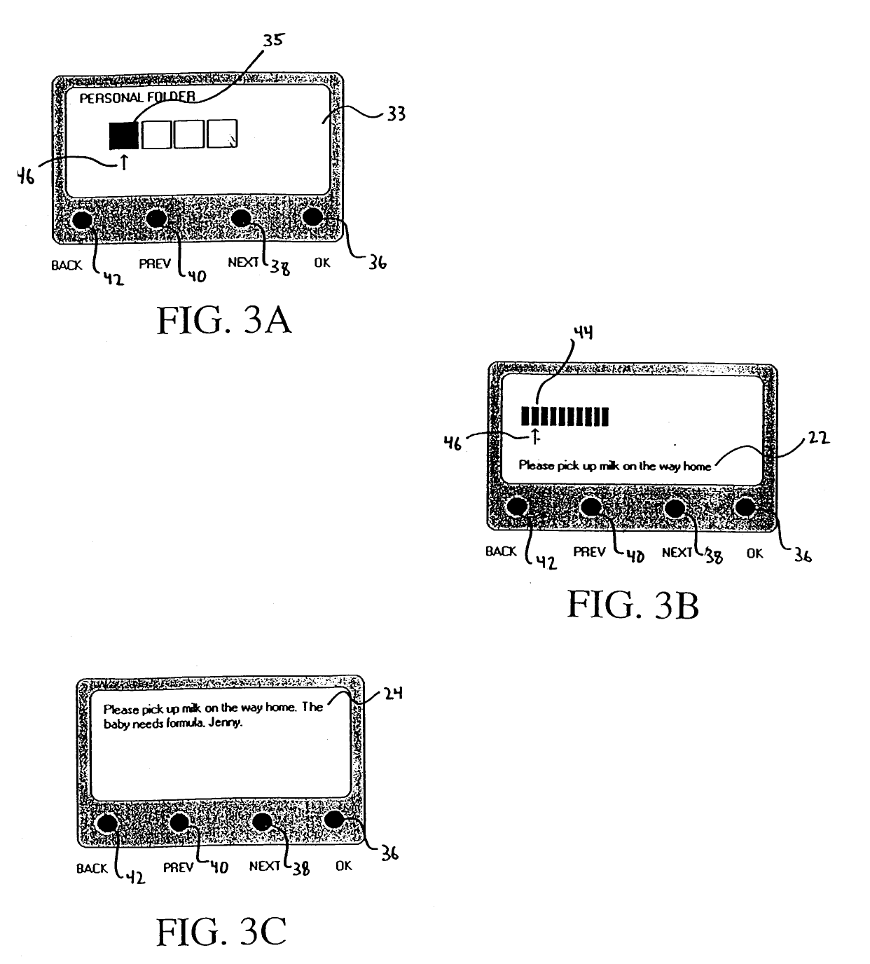

After the first viewing of the advertising indicia and associated message, the user can choose to keep the message in a personal messages memory 15 which is accessed via the interface 5 as the Personal Folder 35 from the Main Menu 33 as seen in FIG. 3A. In order to view a stored message, the user depresses a control button 3. In response, the pager 2 displays a screen as seen in FIG. 3A, allowing the user to access control functions relevant to the screen/function presented. Depressing the “OK” button 36 selects the Personal Message Memory section 15 and displays a new screen as seen in FIG. 3B. The display of FIG. 3B shows the individual messages stored in the personal message memory section 15. Using the “NEXT” button 38 and the “PREV” button 40, the user can navigate the cursor 46 through the full range of indicators 44. To assist the user in selecting messages, the screen additionally displays, below the message indicators 46, a single text line 22 detailing the beginning of the relevant message indicated. This allows the user to glance at the first part of the message stored in the personal message memory 15 and scroll from slot to slot to find a selected message of interest. Depressing the “OK” button 36 allows the user to display the selected message on the display 6, as seen in FIG. 3C.

FIG. 3C shows a selected message 24 stored in the personal messages memory 15 being displayed on the display 6 of the pager 2. Upon the selected message 24 being displayed, the functionality of the “NEXT” button 38 and “PREV” button 40 change so that depressing the NEXT button 38 moves the display screen forward so as to show subsequent screens of the message 24. When the end of the current message 24 is reached, a depression of the NEXT button 38 displays the first screen of the next message in that direction. Similarly, depressing the PREV button 40 moves the display screen backwards in the current message 24 until the beginning of the current message 24. When the beginning of the current message 24 is a reached, depressing PREV button 40 will display the first screen of the message in the previous direction. Depressing the BACK button 42 moves the user up a level in the menu system as seen in FIG. 3B thus allowing the user to move through the full range of indicators 44 and selecting individual messages to be viewed. It should be noted the “OK” button 36, “NEXT” button, 38, “PREV” button 40, and “BACK” button 42 may be arranged in any manner.

### Storing the Advertising Indicia in Memory

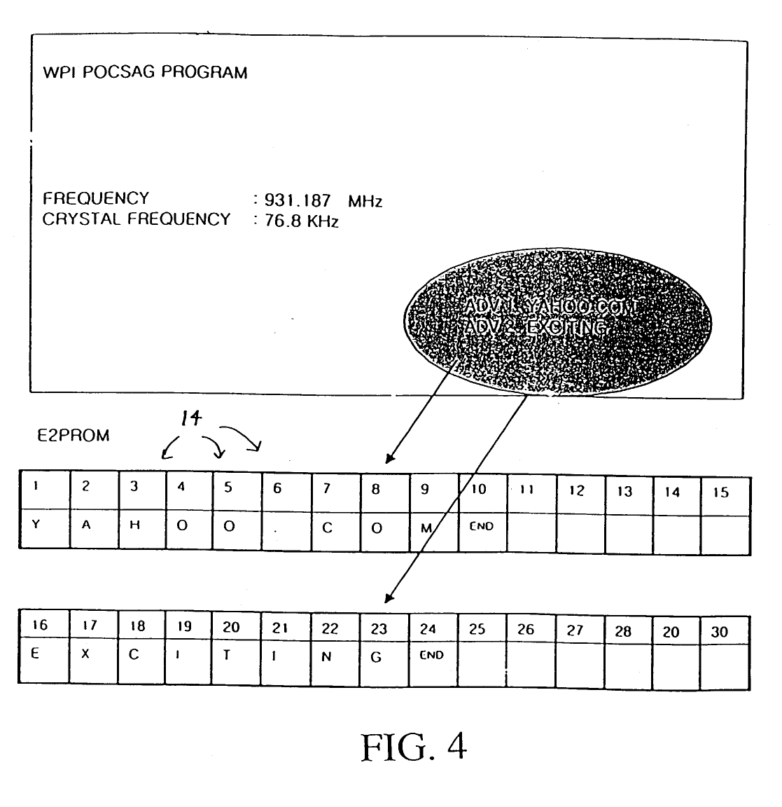

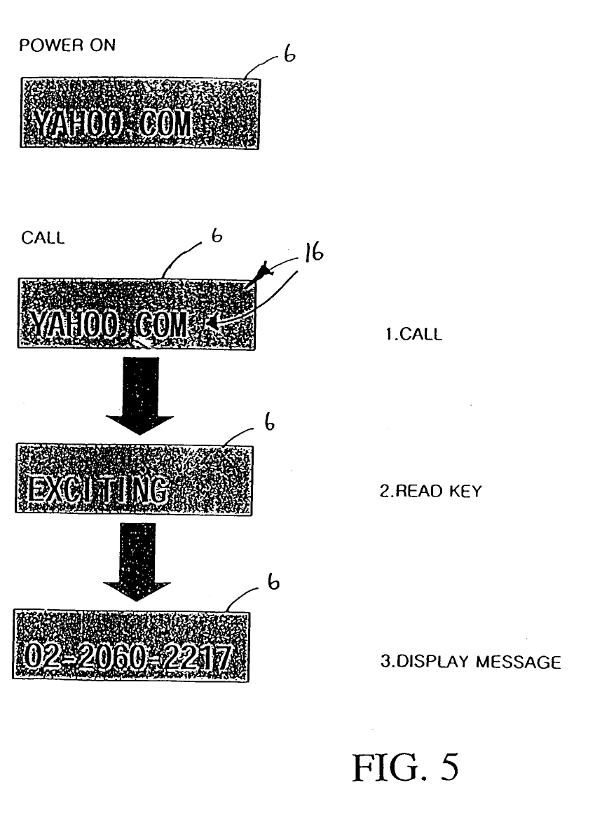

In the embodiment in FIG. 4-FIG. 5, the memory device has several storage locations 14, at least one of which is preprogrammed with advertising indicia. FIG. 4 depicts the company name “YAHOO.COM” (see FIG. 5) preprogrammed in the storage location 14. It should be noted that the advertising indicia may be of a non-commercial manner. As described above, when the controller 10 receives the page signal received by the receiver, the controller 10 sends to the driver 8 a signal comprising the advertising indicia preprogrammed in the memory 12 for causing the display 6 to display the advertising indicia. Thereafter, the controller 10 will send to the driver 8 a signal comprising the message for display on the display 6. As will be described further below, the advertising indicia is preprogrammed, at either the factory or assembly facility where the pager 2 is manufactured, or where the pager 2 is distributed, such as a wholesaler or retailer.

In one embodiment of the present invention, the sellers of the pager devices, in order to make the price more reasonable for the user, if at any price at all, contract directly with a company or person wishing to advertise a product, name, service, or other thing representable through indicia. The seller can, thus, receive a request for placement of advertising indicia within the wireless device 2. The seller or other entity will then store in the memory 12 of the wireless device 2 the advertising indicia. This is done before the user obtains permanent possession of the wireless device, although it can be done after the user has identified in a store or otherwise, which pager 2 the user is interested in using and receiving on a permanent basis. Once the seller has programmed the advertising indicia 16 within the pager 2, the seller provides the wireless device to the user on a permanent basis. This can be done on a no-charge basis. The paging service will then be provided to the user such that when the user receives the page from the source, the advertising indicia 16 stored in the memory 12 of the wireless device 2 will appear on the display 6, in the manner described above.

As mentioned above, the seller of the pager 2 can program the advertising indicia 16 into the pager 2. This can be accomplished by connecting a personal computer 18 to the wireless device 2. This connection may be remote or local and through, for example, an RF connection. Other remote/local means can be used as well. One example of a local means can be a cable 20. The cable 20 can connect through a serial port in the personal computer 18 at one end of the cable 20 and to a EEPROM programming board, having a EEPROM 12 thereon, at the other end of the cable 20. Software is then run on the personal computer 18 that allows for communication between the personal computer 18 and the EEPROM 12 that is then placed in the wireless device 2. Alternatively, the other end of the cable 20 can be directly connected to the wireless device 2. The seller then enters the advertising indicia 16 into the software running on the personal computer 18, and the advertising indicia 16 is then sent to the wireless device 12 from the personal computer 18 for storage in the memory 12, either directly or indirectly through the use of the EEPROM programming board. The connection between the personal computer 18 and the wireless device is then disconnected, either directly or indirectly from the EEPROM programming board.

The advertiser 34 can pay for some or all of the wireless device or associated paging service, if needed. Several different advertising indicia can be preprogrammed into memory before the user receives permanent possession thereof. In a further embodiment of the present invention, when a first page is received, a first advertising indicia, such as “YAHOO.COM” stored in memory 12 can be displayed on the display 6 of the wireless device 2. When a second page is received, a second advertising indicia, such as “COKE” stored in memory 12 can be displayed on the display 6 of the wireless device 2. When more than one advertising indicia are preprogrammed into memory 12, the advertising indicia can alternate being displayed on the display 6. In an even further embodiment, the controller 10 of the wireless device 2 can be programmed to cause the first advertising indicia to appear on the display a particular percentage of the time of the overall number of pages for a given time period. For example if YAHOO and COKE placed advertising requests, and YAHOO paid more than COKE, then the wireless device 2 could be programmed to have a cycle with four slots, and YAHOO would take up three of the four slots, with COKE taking up the fourth slot. Thus, YAHOO would appear three times in a row, for the first three pages, and COKE would come up on the fourth page. This cycle can be repeated. Other numbers of slots in one cycle could also be used. Other programming methods come to mind of one of ordinary skill in the art, so long as the proper percentage of appearances is achieved.

### Maildrop Function/Private Channel

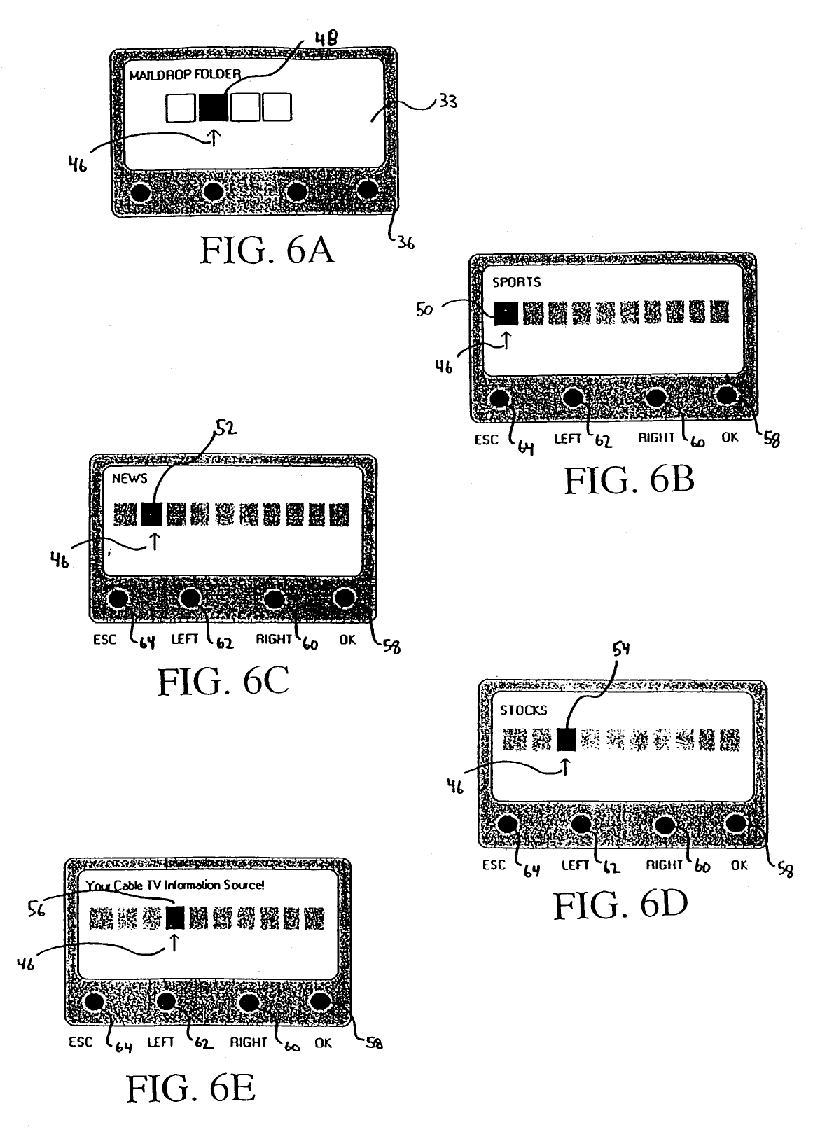

The pager 2 further includes a plurality of channels such as the Maildrop Message Channel, Coupon Channel, and Payment Channel. The Maildrop Message Channel presents advertising messages, rather than personal text messages as described above. The advertising messages are stored in a Maildrop messages memory 17 and are accessed via the interface 5 as the Maildrop Folder 48 as seen in FIG. 6A. Selecting the Maildrop Folder 48 opens a new menu screen presenting a plurality of selected Maildrop Message Channels thereof as seen in FIG. 6B FIG. 6E. The plurality of Maildrop Message Channels may include a Sports Channel 50, a News Channel 52, a Stocks Channel 54, and other Custom channels 56, such as Cable TV Information Source. In addition, the Maildrop Message Channel may include the Coupon Channel and the Payment Channel. It should be noted that the Custom channels 56 would change, dependent upon the advertiser's 34 custom requirements and the demographic criteria of the user of the pager 2, described hereinafter.

Individual pager 2 Maildrop Message Channels may be programmed over the air (OTA) via a unique control capcode. After a user has purchased the pager 2, the pager 2 is activated. This activation may be done via the Internet or over the telephone. When activating the pager 2, the user supplies personal demographic information, such as age, gender, and/or profession. The personal demographic information is utilized to assemble a unique control capcode set for the user. The unique control capcode set comprises capcodes relevant to the demographic information supplied at the time of activation. This unique control capcode is transmitted OTA to the pager 2, thereby programming the Custom channels 56 to receive Maildrop messages intended for members of a sub-set of users that an advertiser 34 wishes to contact.

When the advertiser 34 wishes to contact a sub-set of users, a request is received from the advertiser 34 for placement of a select Maildrop message 26 on the sub-set of users. Confirmation of the receipt of the request is transmitted back to the advertiser. The request comprises the requisite demographic criterion of the sub-set of users thereby allowing identification of the capcodes corresponding to the demographic criterion received from the advertiser 34. In a further embodiment, the request comprises a plurality of different demographic criterion for selecting the sub-set. A page signal is then transmitted such that the wireless devices 2 of the sub-set receive the page signal comprising the selected Maildrop message 26. When the controller 10 receives a page signal comprising the selected Maildrop message 26 received by the receiver, the controller 10 sends a signal to the alarm for notifying to the user that a page has taken place. The controller 10 further sends to the display driver a signal for causing the display 6 to display an identification of the channel from wherein the Maildrop message 26 can be accessed. The Maildrop message 26 is stored in the appropriate channel location in the Maildrop message memory 17 and can be accessed in the manner described above.

In a further embodiment of the present invention, an individual Maildrop Message Channel, such as the Custom Channel 56 may be programmed with the name of a selected advertiser as seen in FIG. 6E. In such circumstances, this Private Channel is reserved for messages originating from a select Private Channel sponsor and allows the Private Channel sponsor to have constant communication with the user of the pager 2. In this manner, it is possible for the Private Channel sponsor to advertise to a select group of users at any time.

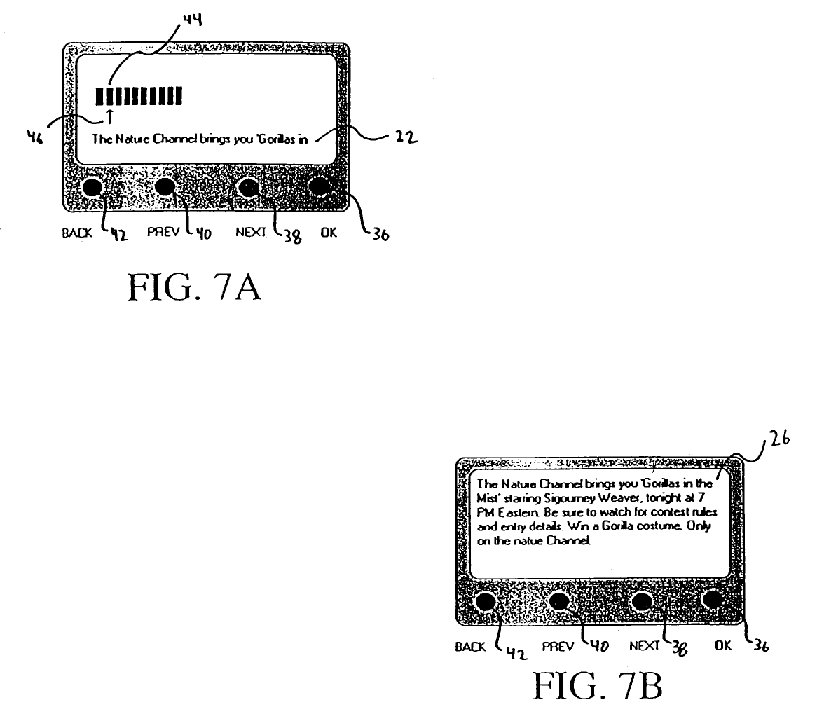

FIG. 6A-FIG. 6E and FIG. 7A-FIG. 7B display the method utilized to read a Maildrop message stored in the Maildrop message memory 17 via Maildrop Folder 48. The access and presentation of the Maildrop message from the Maildrop message memory 17 is similar to the access of the personal message from the personal messages memory 15. In order to view the Maildrop message, the user selects the Maildrop Folder 48 from the Main Menu 33 by depressing the “OK” button 36 as seen in FIG. 6A. In response, the pager 2 displays a screen as seen in FIG. 6B-FIG. 6E allowing the user to access the plurality of Maildrop Message Cannels. The user may utilized the “RIGHT” button 60 and the “LEFT” button 62 to navigate the cursor 46 through the full range of Maildrop Message Channels. To assist the user in selecting a Maildrop Message Channel, the screen additionally displays, above the message channel indicators 50,52,54,56, the title of the selected Maildrop Message Channel. Depressing the “OK” button 58 displays the selected Channel on a new screen as seen in FIG. 7A.

FIG. 7A and FIG. 7B show the method of how a Maildrop message is presented to the user. The display 6, as seen in FIG. 7A, shows the individual Maildrop messages stored in the Maildrop Message Channel 56 of FIG. 6E. Using the “NEXT” button 38 and the “PREV” button 40, the user can navigate the cursor 46 through the full range of indicators 44. To assist the user in selecting messages, the screen additionally displays, below the indicators 44, a single line of text 22 detailing the beginning of the relevant Maildrop message indicated. This allows the user to glance at the first part of the message stored in the Maildrop message memory 17 and scroll from slot to slot to find a selected message of interest. Depressing the “OK” Button 36 allows the user to display the selected message 26 on the display 6, as seen in FIG. 7B.

FIG. 7B shows a selected message stored in the Maildrop messages memory 17 being displayed on the display 6 of the pager 2. Upon the selected message 26 being displayed, the functionality of the “NEXT” button 38 and “PREV” button 40 change so that depressing the NEXT button 38 moves the display screen forward so as to show subsequent screens of the message 26. When the end of the current message 26 is reached, a depression of the NEXT button 38 displays the first screen of the next message in that direction. Similarly, depressing the PREV button 40 moves the display screen backwards in the current message 26 until the beginning of the current message. When the beginning of the current message 26 is a reached, depressing PREV button 40 will display the first screen of the message in the previous direction. Depressing the BACK button 42 moves the user up a level in the menu system as seen in FIG. 7A, thereby permitting navigation through the full range of messages and selection of individual messages to be viewed.

### Dynamic Infrared Transfer System

In a further embodiment of the present invention, the wireless device 2 includes a means to transfer and receive data via electromagnetic signals, such as optical signals. Preferably, the wireless device 2 includes a dynamic infrared transfer system 70 to transfer and receive data via infrared signals. In the preferred embodiment, the dynamic infrared transfer system 70 is connected to the wireless device 2 such that the wireless device 2 supplies the dynamic infrared transfer system 70 with the necessary power, control, and export leads. Preferably, as explained hereinafter, the transfer data is dynamic such that the infrared transfer utilizes pager memory tapping to produce a transfer code for multiple operations. It should be noted that the dynamic infrared transfer system 70 may be added as an enhancement to an existing device, such that the existing device provides the necessary power, control and export leads, such as data export leads. Alternately, it is possible for the dynamic infrared transfer system to be configured with a dedicated control system such that it operates independently of the wireless device's 2 functionality. Further, due to the high-speed and short range of data transfer in the dynamic infrared transfer system 70, it is preferable that a standard IrDA data protocol be utilized. However, the inherent flexibility of the dynamic infrared transfer system 70 permits the pager 2 to accept a complete spectrum of defined data types and data protocols.

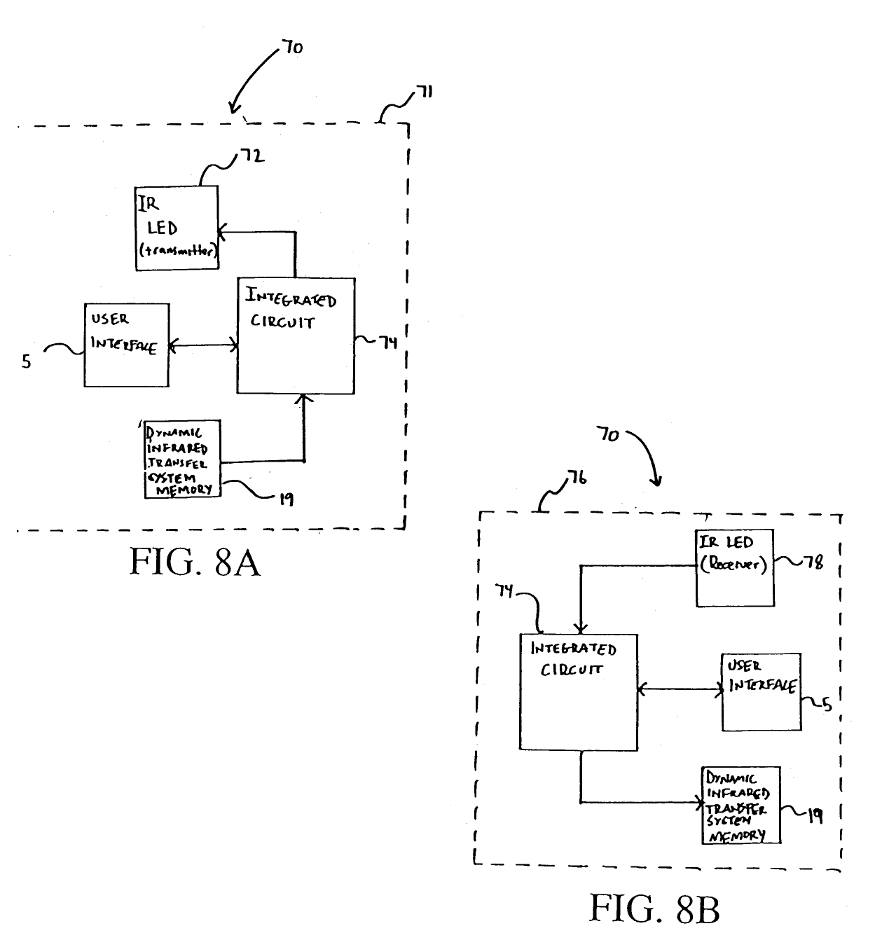

With reference to FIG. 8A, the dynamic infrared transfer system 70 includes a transmitter module 71. The transmitter module 71 comprises a transmitter infrared light emitting diode (IR LED) 72, an integrated circuit (IC) chip 74 having an IC memory and data encryption software connected to the IR LED transmitter 72 for driving the IR LED transmitter 72, and a user interface 5 section for operating the dynamic infrared transfer system 70. Further, the pager 2 has a dynamic infrared transfer system memory 19 having data, such as coupon information, financial information, and other types of identification information as will be discussed hereinafter.

As mentioned above, the pager 2 has dynamic infrared transfer system memory 19 having various types of personal information data stored therein. The dynamic infrared transfer system 70 utilizes the dynamic infrared transfer system memory 19 to copy selected transfer data into the IC memory. The selected transfer data is configured for transmission via the IR LED transmitter 72, in a manner known by one of ordinary skill in the art. The transmitter IR LED 72 utilizes invisible modulated infrared light as a transmission medium thereby avoiding problems associated with radio frequency (RF) interference and electromagnetic radiation (EMR) interference.

In an even further embodiment of the present invention, the dynamic infrared transfer system 70 comprises a receiver module 76. With reference to FIG. 8B, the receiver module 76 includes an IR LED receiver 78 and an integrated circuit (IC) chip 74 having an IC memory and data decoding software connected to the IR LED receiver 78 for decoding data received by the IR LED receiver 78. In order to utilize fewer hardware components, the dynamic infrared transfer system 70 may comprise an IR LED transceiver (not shown) that comprises both the IR LED transmitter 72 and the IR LED receiver 78. Preferably, the receiver module utilizes the same IC chip 74 and user interface 5 as the transmitter module 71; however, the receiver module 76 may utilize a separate IC chip and a separate interface. Upon receiving data by the IR LED receiver 78, the IC chip 74 transmits the received data to the dynamic infrared system memory 19. Preferably, the data is transferred via a RS232 standard serial interface thereby allowing the dynamic infrared transfer system 70 to be utilized with a plurality of host systems in addition to the pager 2. The IC chip 74 further decodes the received data so that the pager 2 may utilize it. The addition of the receiver module 76 allows for flexibility of application of the dynamic infrared transfer system 70 such that data intended for transport via the dynamic infrared transfer system interface 5 can be loaded into the pager 2 via the infrared transfer in addition to traditional input means, such as RF signals.

### Coupon Channel

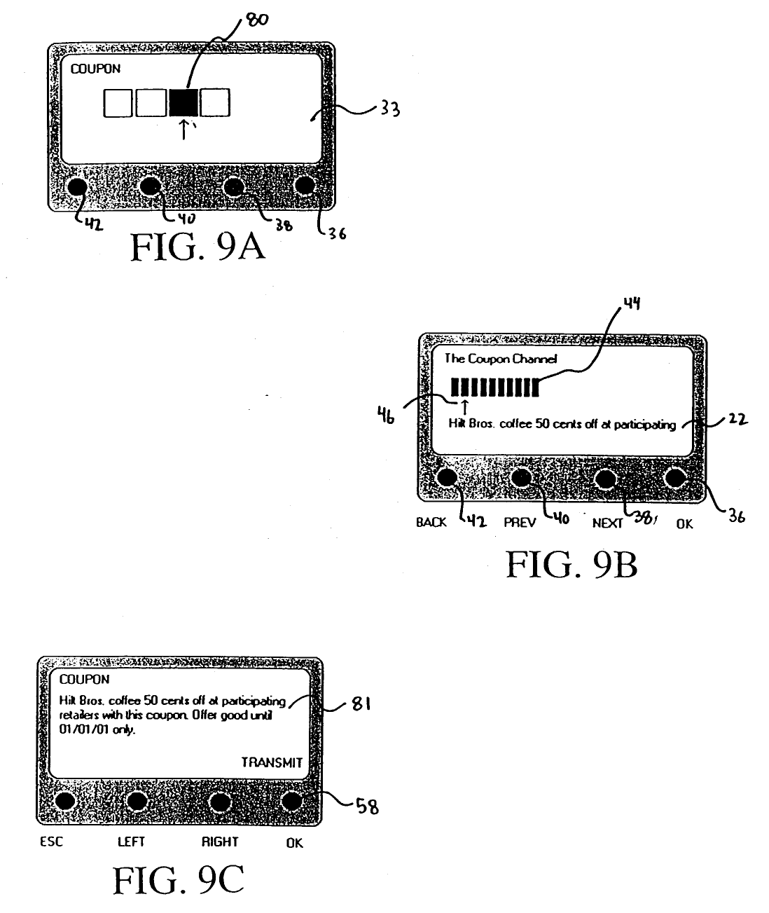

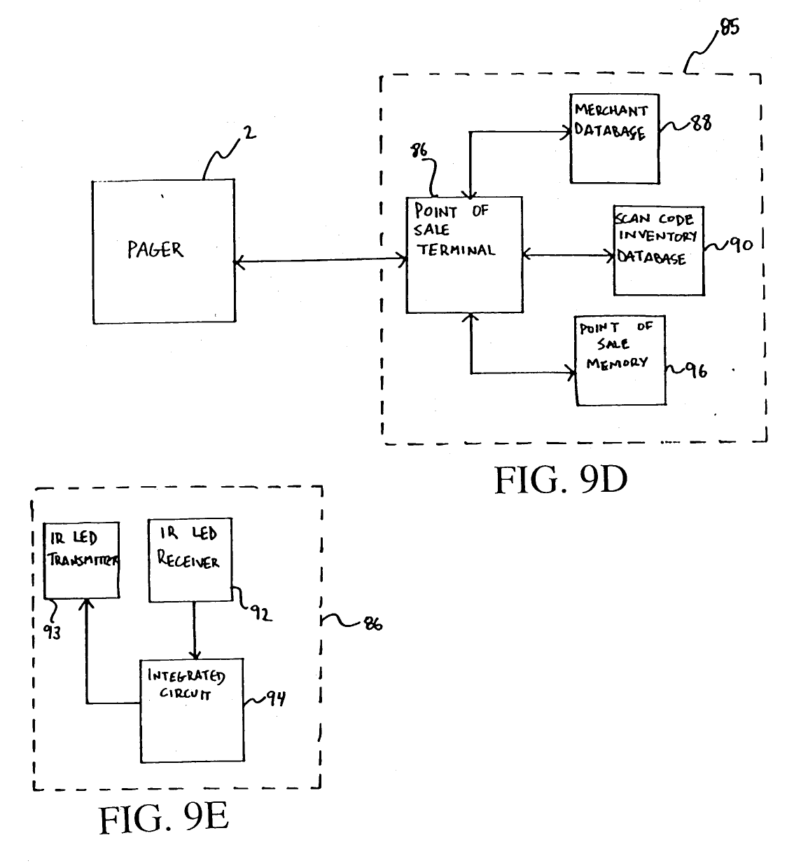

In one embodiment of the present invention, the pager 2 may utilize the dynamic infrared transfer system 70 to receive a discount in a financial transaction. FIG. 9A-FIG. 9E illustrate a user using the pager 2 and dynamic infrared transfer system 70 therein to present a coupon to a merchant or manufacturer at a point of sale system 85. With reference to FIG. 9D, the point of sale system 85 includes a point of sale terminal 86, a merchant database 88, a scan code inventory database 90 and a point of sale memory 96.

As mentioned above, the pager 2 includes a Coupon Channel 80 having coupons that can be accessed similar to accessing advertising messages in the Maildrop Message Channel via the main menu 33. The Coupon Channel 80 receives the coupons in a in a manner similar to the advertising messages received by the Maildrop Folder 48. The received coupons are stored in a coupon memory 84 and are accessed via the interface through the Coupon Channel 80 as seen in FIG. 9A. Selecting the Coupon Channel 80 opens a new menu screen presenting a plurality of coupons messages stored in the Coupon Channel 80 as seen in FIG. 9B. Using the “NEXT” button 38 and the “PREV” button 40, the user can navigate the cursor 46 through the full range of indicators 44. To assist the user in selecting coupon, the screen additionally displays, below the indicators 44, a single line of text 22 detailing the beginning of the relevant coupon indicated. This allows the user to glance at the first part of the coupon stored in the Coupon memory 84 and scroll from slot to slot to find a selected coupon of interest. Depressing the “OK” Button 36 allows the user to display the selected coupon on the display 6, as seen in FIG. 9C.

FIG. 9C shows a selected coupon 81 stored in the coupon memory 17 being displayed on the display 6 of the pager 2. Upon the selected coupon 81 being displayed, the functionality of the “NEXT” button 38 and “PREV” button 40 change so that depressing the NEXT button 38 moves the display screen forward so as to show subsequent screens of the coupon. When the end of the current coupon 81 is reached, a depression of the NEXT button 38 displays the first screen of the next coupon in that direction. Similarly, depressing the PREV button 40 moves the display screen backwards in the current coupon 81 until the beginning of the current coupon 81. When the beginning of the current coupon 81 is reached, depressing PREV button 40 will display the first screen of the coupon in the previous direction. Depressing the BACK button 42 moves the user up a level in the menu system as seen in FIG. 9B, thus allowing navigation through the full range of coupons and selection of individual coupons to be viewed.

FIG. 9C illustrates a coupon 81 displayed on the display 6. At the point of sale terminal 86, a depression of the “OK” button 58 to activates the transmitter module 71 of the dynamic infrared transfer system 70. The IC chip 74 copies the selected coupon from the coupon memory 84 to the IC memory and configures the data for infrared transmission. The IC chip 74 sends a signal comprising the configured selected coupon data and the pager's identity to the IR LED transmitter for transmission to the point of sale terminal 86.

As mentioned above, the point of sale system 85 includes the point of sale terminal 86 illustrates in FIG. 9E. The point of sale terminal includes an infrared LED (IR LED) receiver 92, an infrared LED transmitter 93, and a integrated chip (IC) 94 connected to the IR LED receiver 92 and IR LED transmitter 93. The IR LED receiver 92 receives the signal comprising the configured selected coupon data and the pager's identity transmitted by the pager 2 and transmits said signal to the IC chip 94. Upon receiving the signal, the IC chip 94 transmits the received data to a point of sale memory 96 and decodes the infrared signal so that the point of sale system 85 can utilize it. Further, the IC chip 94 may send a signal comprising a confirmation of receipt to the IR LED transmitter 93 for transmission of the confirmation of receipt to the pager 2. In the event of a bad transmission from the pager 2 to the IR LED receiver 92, the IC chip 94 may send a signal requesting retransmission of the signal comprising the coupon data. The point of sale system 85 uses the merchant database 88 to apply the relevant merchandise discount to the user's purchase based upon the merchants scan code inventory database 90.

In a further embodiment of the present invention, the user does not have to select a coupon to send. Rather, all of the coupons are transmitted. The IC chip 74 copies all the coupons from the coupon memory 84 to the IC memory and configures the data for infrared transmission. The IC chip 84 sends a signal comprising the configured coupon data and the pager's identity to the IR LED transmitter for transmission to the point of sale terminal 86. The point of sale terminal 86 receives the coupon data in the manner described above. The point of sale system 85 uses the merchant database 88 to apply the relevant merchandise discount to the relevant portion of the user's purchase. The point of sale terminal 86 transmits a killcode to the pager 2 deleting the coupons used in the current purchase.

In an even further embodiment, the point of sale terminal includes a RF receiver (not shown) for receiving verification information for a plurality of pagers 2. The verification information is stored in a memory, such as the point of sale memory 96, connected to the IC chip 94. Upon receiving the signal comprising the configured selected coupon data and the pager's identity transmitted by the pager 2, the IC chip compares the information comprising the signal with the corresponding verification data to authenticate the transaction.

### Financial Payment

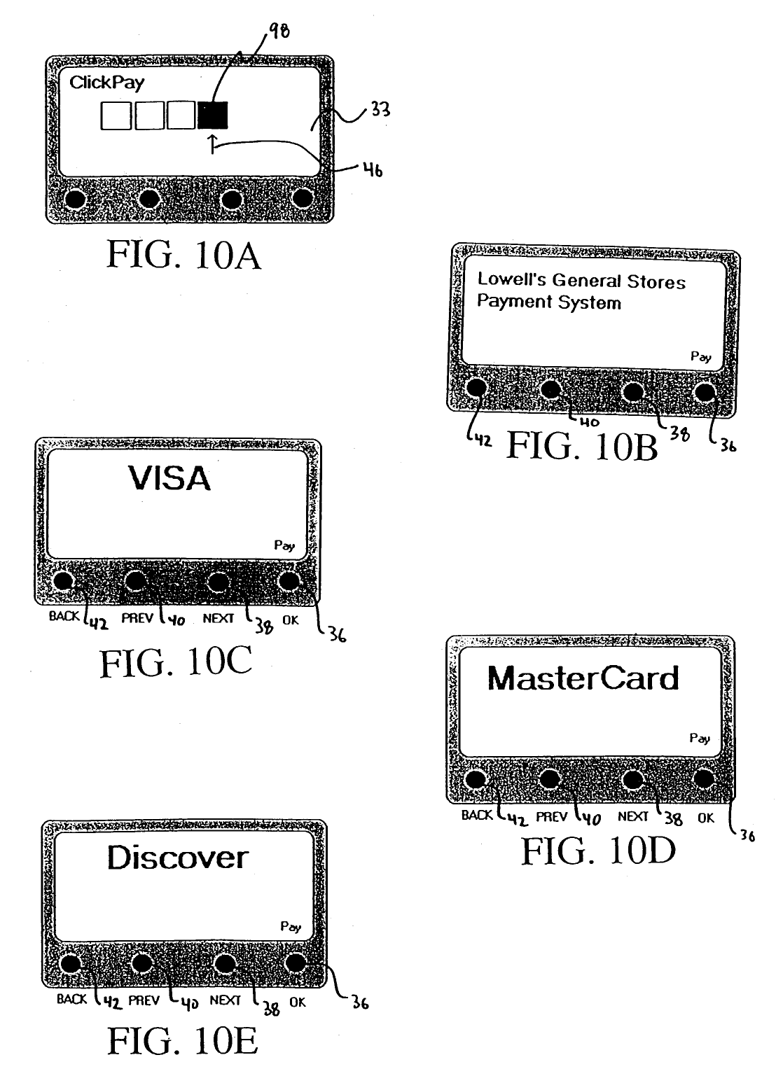

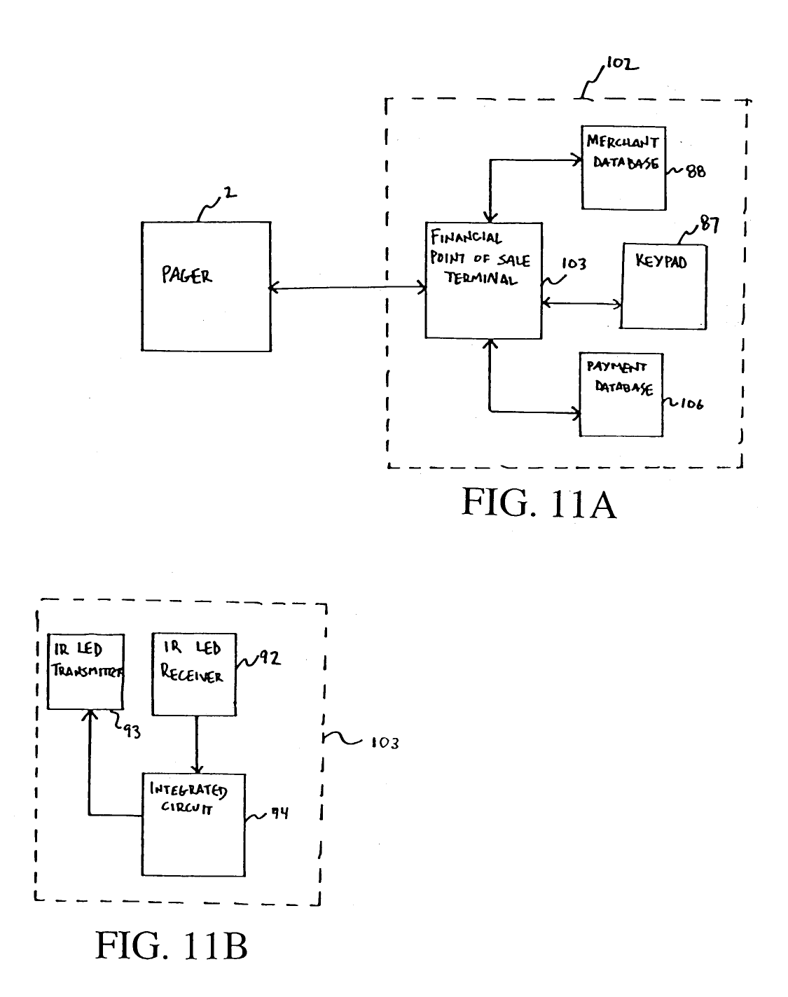

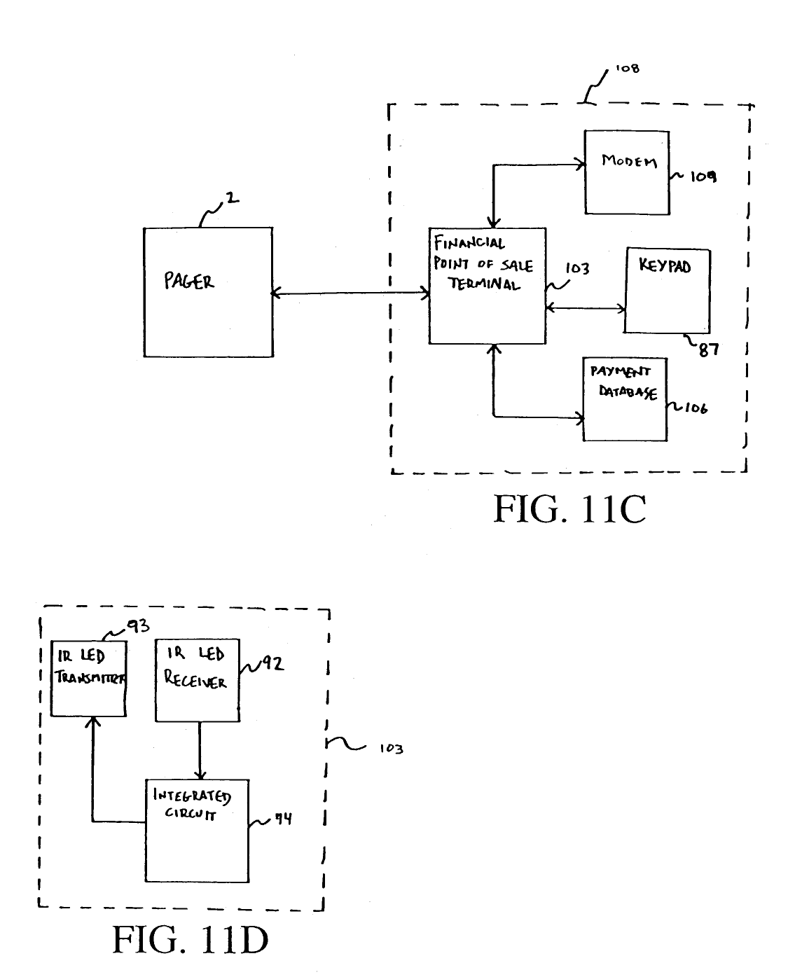

In a further embodiment of the present invention, the pager 2 may use the dynamic infrared transfer system 70 to make a financial payment in a financial transaction. FIGS. 10A-10E illustrate the pager 2 and the dynamic infrared transfer system 70 therein to present a payment, such as a credit card or a debit card, to a merchant or manufacturer at a payment system 102. With reference to FIG. 11A, the point of sale system 102 includes a merchant database 88, a financial point of sale terminal 103, a pad 87 and a payment database 106.

As mentioned above, the pager includes a Payment Channel 98 having payment information that can be accessed similar to the coupons in the Coupon Channel 80 via the main menu 33. FIG. 10B illustrates a user utilizing a selected merchants optional merchant payment system 102, such as Lowell's General Stores Payment System. In this manner, the payment system 102 comprises data in the merchant database 88 relating to a user's payment information, such as a debit card number. When the user shops at a merchant participating in the optional merchant payment system 102, the user presents the dynamic infrared transfer system 70 enabled pager 2 to the optional merchant payment system 102. The payment information is stored in the dynamic infrared transfer system memory 19 and is accessed via the interface as the Payment Channel 98. Selecting the Payment Channel 98 opens a new menu screen presenting payment information as seen in FIG. 10B. Selecting the “OK” button 36 activates the transmitter module 71 of the dynamic infrared transfer system 70. The IC chip 74 copies the payment information from the dynamic infrared transfer system memory 19 to the IC memory and configures the payment information for infrared transmission. The IC chip 74 sends a signal comprising the configured payment information and the pager's identity to the IR LED transmitter 72 for transmission to the optional merchant payment system 102. Further, the payment information stored in the dynamic infrared transfer system memory 19 may comprise a selected amount. Upon transmission of the configured payment information, the IC chip 74 may deduct the payment amount from the selected amount in memory. In this manner, the pager 2 is similar to using a debit card.

Referencing FIG. 1I B, the financial point of sale terminal 103 includes an infrared LED (IR LED) receiver 92, an infrared LED transmitter, and an integrated chip (IC) 94 connected to the IR LED receiver 93 and IR LED transmitter 93. The IR LED receiver 92 receives the signal comprising the configured payment information and the pager's identity transmitted by the pager 2 and transmits the signal to the IC chip 94. Upon receiving the signal, the IC chip 94 transmits the received data to a payment database 106 and decodes the infrared signal so that the optional merchant payment system 102 can utilize it. Further, the IC chip 94 may send a signal comprising a confirmation of receipt to the IR LED transmitter 93 for transmission of the confirmation of receipt to the pager 2. The optional merchant payment system 102 utilizes the merchant database 88 to determine the user's payment choice, such as a credit card or a debit card transaction and applies said payment choice to the transaction. The optional merchant payment system 102 may verify the transaction utilizing a user-inputted personal identification number.

In an even further embodiment of the present invention, a multiple payment system 108, as seen in FIG. 11C, may be utilized thereby bypassing the optional merchant payment system 102. The multiple payment system 108 accesses credit card systems through a modem 109, or any method as known by one of ordinary skill in the art. Preferably, a plurality of payment information is stored in the dynamic infrared transfer system memory 19 for subsequent access by the pager 2 having the dynamic infrared transfer system 70. The payment information may be stored in the memory 19 at a manufacturing facility before the user obtains permanent possession or through a remote connection, such as an RF signal. The multiple payment system 108 includes the financial point of sale terminal 103, the payment database 106 and a means for transmitting payment information to a payment verification service, such as a modem 109.

As mentioned above, the pager includes a Payment Channel 98 having payment information that can be accessed similar to the coupons in the Coupon Channel 80 via the main menu 33. FIGS. 10C-10E illustrates a user utilizing the pager in the multiple payment system 108 configuration. Selecting the Payment Channel 98 opens a new menu screen displaying a payment option, such as a VISA credit card payment, stored in the dynamic infrared transfer system memory 19, as seen in FIG. 10C. Using the “NEXT” button 38 and the “PREV” button 40, the user can navigate through the full range of payment options stored in the dynamic infrared transfer system memory 19. The full range of payment options may include a MasterCard credit card and/or Discover credit card as seen in FIGS. 10D and 10E.

Depressing the “OK” button 36 activates the transmitter module 71 of the dynamic infrared transfer system 70. The IC chip 74 copies the payment information from the dynamic infrared transfer system memory 19 to the IC memory and configures the payment information for infrared transmission. The IC chip 74 sends a signal comprising the configured payment information and the pager's identity to the IR LED transmitter 72 for transmission to the multiple payment system 108.

With reference to FIG. 11D, the financial point of sale terminal 103 of the multiple payment system 108 includes an infrared LED (IR LED) receiver 92, an infrared LED transmitter 93, and an integrated chip (IC) 94 connected to the IR LED receiver. The IR LED receiver 92 receives the signal comprising the configured payment information and the pager's identity transmitted by the pager 2 and transmits the signal to the IC chip 94. Upon receiving the signal, the IC chip 94 transmits the received data to the payment database 106 and decodes the infrared signal so that the multiple payment system 108 can utilize it. Further, the IC chip 94 may send a signal comprising a confirmation of receipt to the IR LED transmitter 93 for transmission of the confirmation of receipt to the pager 2. In addition, the financial point of sale terminal 103 may include a RF receiver (not shown) for receiving verification information for a plurality of pagers 2. The verification information is stored in a memory connected to the IC chip 94. Upon receiving the signal comprising the configured payment information the pager's identity transmitted by the pager 2, the IC chip compares the information comprising the signal with the corresponding verification data to authenticate the transaction.

The multiple payment system 108 utilizes a standard payment verification system, such as a credit card service to verify the payment option. Further, the multiple payment system 108 may be connected to a standard financial network, such as an ATM network. The multiple payment system 108 applies the payment option to the transaction. Similar to the optional merchant payment system 102, the multiple payment system 108 may utilize a user inputted personal identification number to verify the transaction. However, unlike the optional merchant payment system 102, the multiple payment system 108 does not require a merchant to utilize a merchant database. Rather the multiple payment system 108 utilizes a standard credit card service that the merchant subscribes to verify credit card information. Further, the pager 2 may permit a user to utilize both the optional merchant payment system 102 and the multiple payment system 108 using a single dynamic infrared transfer system 70.

In order to address security concerns, the pager's 2 unique control capcode allows the data residing in a pager memory, such as pager configuration, personal messages stored in the personal message memory 15, Maildrop messages stored in Maildrop message memory 17, and all data stored in the dynamic infrared transfer system memory 19, to be destroyed via a kill code. The kill code is transmitted via a radio frequency signal to the pager 2. The controller 10 receives the page signal sent to the controller 10 by the receiver, after the receiver receives the signal, the controller deletes the aforementioned data residing in the pager memory. The use of the kill code in conjunction with the point of sale personal identification number input provides a high level of security in utilizing the pager 2 having dynamic infrared transfer system 70 to complete a financial transaction.

### Access Control System

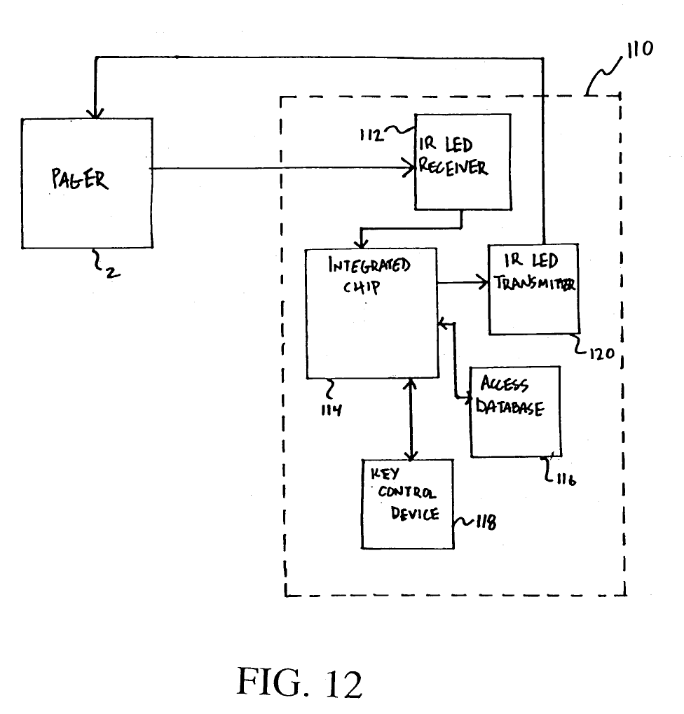

It should be noted that the pager 2 having the dynamic infrared transfer system 70 can be utilized in a plurality of additional scenarios. In one embodiment of the present invention, the pager 2 having the dynamic infrared transfer system 70 can be used in an access control system 110 as an electronic key, as seen in FIG. 12. Standard access enable/denial systems, as known by one of ordinary skill in the art, can be enhanced by the addition of the access control system 110 so as to permit communication with the pager 2 having the dynamic infrared transfer system 70. The access control system 110 may be added to any device that requires authorization to access.

In the present embodiment, the pager 2 would include an Identification Channel having the user's identification data stored in the dynamic infrared transfer system memory 19. The Identification channel is accessed in a manner similar to the Coupon Channel 80, via the main menu 33. The pager 2 transmits the identification data via the transmitter module 71 of the dynamic infrared transfer system 70. The IC chip 74 copies the identification data from the dynamic infrared transfer system memory 19 to the IC memory and configures the identification data for infrared transmission. The IC chip 74 sends a signal comprising the configured identification data and the pager's identity to the IR LED transmitter 72 for transmission to the access control system 110.

The access control system 110 of FIG. 12 includes an infrared LED (IR LED) receiver 112, an infrared LED transmitter 120, and an integrated chip (IC) 114 connected to the IR LED receiver 112 and is connected to an access controlled device 118. The IR LED 112 receives the signal comprising the configured identification data and the pager's identity transmitted by the pager 2 and transmits the signal to the IC chip 114. The IC chip 114 may send a signal comprising a confirmation of receipt to the IR LED transmitter 120 for transmission of the confirmation of receipt to the pager 2. Upon receiving the signal comprising the configured identification data, the IC chip 114 transmits the received data to a access database 116 and decodes the infrared signal to the access control system can utilize the identification data to enable or disable access to access controlled device 118. The access control device 118 may be any device that requires authorization to access, such as computer equipment requiring a login, vehicles, and hazardous or private areas where it is desirable to deny access to unauthorized users, such as a home.

In an even further embodiment of the present invention, the identification data stored in the dynamic infrared transfer system memory 19 is utilized to track a user's usage of a resource, such as a library, or attendance, such as in a classroom setting. The system would be enabled in a manner similar to the access control access system 110.

### Voicemail System

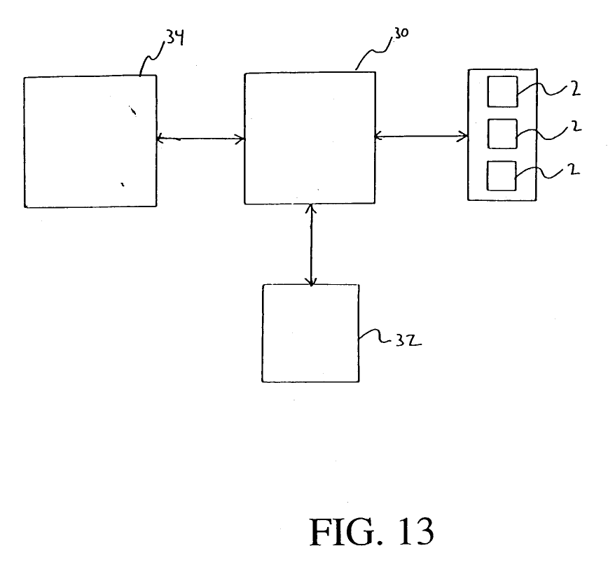

With reference to FIG. 13, a further embodiment, the present invention includes a method for providing advertising to a sender 32 of a page to the wireless device 2. The plurality of wireless devices 2 is provided to an advertiser 34 who may want to advertise to a sender 32 of a page to one of a plurality of wireless devices 2. A request is received from the advertiser 34 for placement of an audible advertising message on a voice mail system 30. Confirmation of receipt of the request is transmitted back to the advertiser. The request may direct that the audible advertising message be provided to sender 32 of a page and/or to a sub-set of users of the wireless devices 2. The audible advertising message is provided to the sender 32 of the page in response to the sender 32 of the page requesting to leave a voice mail message directed specifically to the identity of the wireless device 2. The advertising message may be provided to the sender 32 of the page prior to leaving the voice mail message. Paging service is provided to the wireless device 2 having the specified identity for notifying the user of the voice mail message wherein the user calls the voice mail system to hear the voice mail message directed specifically to the identity of the wireless device 2 of said user. The audible advertising message is provided to the user prior to hearing the voice mail message.

When the request for placement indicates that an audible advertising message is to be provided to sub-set of wireless devices 2, the request comprises demographic criteria. The identities of the sub-set are determined wherein the identities have user demographic information corresponding to the demographic criteria received from the advertiser 34. The demographic criteria may be age, gender, and/or profession. The paging service is provided to the wireless devices 2 such that the wireless devices 2 of the sub-set receive a page signal directed specifically to the identity of the wireless device 2 for notifying a user of a voice mail message wherein the user calls the voice mail system 30 to hear the voice mail message directed specifically to the identity of the wireless device 2. The audible advertising message is provided to the user prior to hearing the voice mail message.

### Website Banner

In a further embodiment, the present invention is a method of providing advertising to a sender 32 of a page to a user of a wireless device 2. A website is provided to a sender 32 for sending a page to a user of a wireless device 2. The website comprises a field for identifying the identity of the wireless device and a field for identifying the message. A request is received from the advertiser 34 for placement of advertising indicia through the website. Confirmation of receipt of the request is transmitted back to the advertiser. The advertising indicia is displayed in response to the sender 32 sending the page message.

While the specific embodiments have been illustrated and described, numerous modifications come to mind without significantly departing from the spirit of the invention and the scope of protection is only limited by the scope of the accompanying claims.

What is claimed is:

1. A method for providing advertising indicia to a plurality of users of wireless devices on a display on each of the wireless devices, the wireless devices for notifying a respective user of a wireless message directed specifically to a respective one of the wireless devices, the method comprising the steps of:
distributing a plurality of the wireless devices to a group of users wherein each wireless device has an identification;
receiving a request for placement of advertising indicia on a sub-set of the plurality of users of wireless devices wherein the request for placement of advertising indicia comprises a demographic criterion for selecting the sub-set;
determining the identifications of the wireless devices of the sub-set; and,
providing paging service to the plurality of users, wherein only the wireless devices of the sub-set receive the advertising indicia.

2. The method of claim 1 further comprising a step wherein a single wireless device in the sub-set receives a page signal.

3. The method of claim 2 wherein the page signal comprises a message and the advertising indicia.

4. The method of claim 3 wherein the page signal comprises a first channel having the message and second channel having the advertising indicia, wherein the first channel is independent of the second channel.

5. The method of claim 3 wherein the advertising indicia is displayed on a display of the wireless device prior to the message being displayed on the display.

6. The method of claim 3 wherein the advertising indicia is displayed on a display of the wireless device subsequent to the message being displayed on the display.

7. The method of claim 3, wherein the message is a number to call.

8. The method of claim 3, wherein the message comprises a name of a person and a alphanumeric message.

9. The method of claim 1, wherein the wireless device is continuously attempting to detect the page signal directed specifically to the wireless device

10. The method of claim 1, wherein the advertising indicia is a directed message.

11. The method of claim 1, wherein the advertising indicia is a logo.

12. The method of claim 1, wherein the advertising indicia is a full motion graphic.

13. The method of claim 12, wherein the full motion graphic is a FLASH graphic.

14. The method of claim 1, wherein the wireless device is a wireless messager.

15. The method of claim 1, wherein the wireless device is a cellular phone

16. The method of claim 1, wherein the wireless device is a personal digital assistant.

17. The method of claim 1, wherein the advertiser pays for at least a portion of the wireless device.

18. The method of claim 1, wherein the advertiser pays for at least a portion of the paging service.

19. The method of claim 1, wherein the demographic criterion determining the sub-set is at least one of age, date of birth, marital status, child status, adult status, income range, profession, hobby, and location.

20. The method of claim 19, wherein child status is defined as less than the age of eighteen years old.

21. The method of claim 19, wherein location can be determined by at least one of address, city, state, zip code, country, voting district, township, e-mail domain, and e-mail address.

22. A method of providing advertising to a sender of a wireless message to a respective user of a wireless device, the wireless device for notifying the respective user of a wireless message directed specifically the wireless device, the method comprising:
distributing a plurality of wireless devices to a group of users wherein each wireless device has an identification;
receiving a request for placement of an audible advertising message on a voice mail box; and,
providing the audible advertising message to the sender of the wireless message in response to the sender of the wireless message requesting to leave a voice mail message directed the wireless device of a selected user.

23. The method of claim 21, wherein the audible advertising message is provided to the sender prior to leaving the voice mail message directed to the wireless device of the selected user.

24. The method of claim 21 further comprising a step of providing a paging service to the selected user for notifying the selected user of the voice mail message wherein the selected user calls the voice mail system to hear the voice mail message directed to the wireless device of said selected user.

25. The method of claim 24, wherein the audible advertising is provided to the user of the wireless device when said user calls the voice mail system to hear the voice mail message directed specifically to the identity of the wireless device of said user.

26. The method of claim 25, wherein the audible advertising is provided to the user prior to hearing the voice mail message.

27. The method of claim 24, wherein the request for placement of an audible advertising message comprises demographic criteria.

28. The method of claim 27, further comprising a step for determining a sub-set of a plurality of wireless devices wherein the sub-set has user demographic information corresponding to the demographic criteria from the advertiser.

29. The method of claim 28, wherein the audible advertising message is provide to a user in the sub-set when the user in the sub-set calls the voice mail system to hear the voice mail message directed to the wireless device of said user.

30. A method for providing advertising to a sender of a wireless message to a selected user of a wireless device, the wireless device for notifying the selected user of a message directed to the wireless device, the method comprising:
providing a website to a sender for sending a wireless message to a selected user of a wireless device, the website having a field for identifying the wireless device and a field for providing a message;
receiving a request from an advertiser for placement of advertising indicia through the website; and,
displaying the advertising indicia on the website in response to the sender transmitting the wireless message through the website to the identified wireless device.

31. The method of claim 30, wherein the advertising indicia is a name of the advertiser wherein the name is a link to the website of the advertiser.

32. A system for providing a financial transaction to a user of a wireless device, the system comprising:
an interactive point of sale terminal connected to an financial network, the point of sale terminal comprising an input device for entering a personal identification number and an electromagnetic receiver for receiving an electromagnetic signal; and
a wireless device for transmitting an electromagnetic signal to the interactive point of sale terminal, the wireless device comprising an identification corresponding to a personal identification number, a memory comprising financial information, a processor connected to the memory for processing the financial information and wireless device identification to form an electromagnetic transaction signal, and a transmitter connected to the processor for transmitting the electromagnetic transaction signal to the interactive point of sale terminal.

33. The system of claim 32 wherein the financial information comprises a single credit card number.

34. The system of claim 32 wherein the financial information comprises a plurality of credit card numbers.

35. The system of claim 34, wherein the wireless device comprises a selection means for selecting one of the plurality of credit cards to transmit to the interactive point of sale terminal.

36. The system of claim 32 wherein the financial information comprises a coupon.

37. The system of claim 32, wherein the electromagnetic signal is an infrared signal.

38. The system of claim 32, wherein the interactive point of sale terminal further comprises an electromagnetic transmitter for transmitting an electromagnetic query signal to the wireless device.

39. The system of claim 38, wherein the electromagnetic query signal comprises a verification request.

40. The system of claim 38, wherein the electromagnetic query signal comprises a resend request.

41. The system of claim 32, wherein the wireless device further comprises an electromagnetic receiver for receiving an electromagnetic signal.

42. A method for completing a financial transaction utilizing a system having an interactive point of sale terminal and a wireless device for transmitting an electromagnetic signal to the interactive point of sale terminal, the method comprising:
receiving an electromagnetic transaction signal from a wireless device having an identification, the electromagnetic transaction signal comprising financial information; and
requesting a user to input a personal identification number (PIN) wherein the PIN corresponds to the identification of the wireless device;

43. The method of claim 42, wherein the financial information comprises credit card information.

44. The method of claim 42, wherein the financial information comprises debit card information.

45. The method of claim 42, wherein the electromagnetic signal is an infrared signal.

46. The method of claim 42 further comprising a step of transmitting an electromagnetic query signal wherein the electromagnetic query signal comprises a verification request.

47. The method of claim 42 further comprising a step of transmitting an electromagnetic query signal wherein the electromagnetic query signal comprises a resend request.

48. A wireless device for use in a financial transaction, the wireless device comprising:
an identification;
a memory comprising financial information;
a processor connected to the memory for processing the financial information and identification to form an electromagnetic transaction signal; and
a transmitter connected to the processor for transmitting the electromagnetic transaction signal to an interactive point of sale terminal.

49. The wireless device of claim 48 further comprising a receiver connected to the processor for receiving an electromagnetic signal.

50. The wireless device of claim 48, wherein the identification corresponds to a personal identification number.

51. The wireless device of claim 48, wherein the electromagnetic signal is an infrared signal.

52. A system for permitting access to a device, the system comprising:
a access control system connected to a device requiring controlled access, the access control system having an infrared receiver for receiving an infrared signal; and
a wireless device including means for transmitting an electromagnetic signal to the access control system, the wireless device comprising an identification, a memory comprising identification information, a processor connected to the memory for processing the identification information to form an infrared signal having the identification information, and a transmitter connected to the processor for transmitting the infrared signal to the access control system.

53. The system of claim 52, wherein the electromagnetic signal is an infrared signal.

54. An interactive point of sale terminal with a financial network for use in a financial transaction, the interactive point of sale terminal comprising:
a means for interfacing the interactive point of sale terminal with the financial network;
a means for receiving an electromagnetic signal from a wireless device having an identification, wherein the electromagnetic signal comprises financial information and the identification of the wireless device;
a means for receiving verification information for verifying the electromagnetic signal received from the wireless device wherein the verification information comprises verification data for a plurality of wireless devices;
a means for storing verification information; and
a means for processing the verification information and the wireless device identification to verify the authenticity of the financial information received from the wireless device.
